(19) United States
(12) Patent Application Publication
(10) Pub. No.: US 2018/0109754 A1
(43) Pub. Date: Apr. 19, 2018

(54) IMAGE PROVIDING APPARATUS AND METHOD

(71) Applicant: Hanwha Techwin Co., Ltd., Changwon-si (KR)

(72) Inventor: Yong Jun KWON, Changwon-si (KR)

(73) Assignee: Hanwha Techwin Co., Ltd., Changwon-si (KR)

(21) Appl. No.: 15/417,542

(22) Filed: Jan. 27, 2017

(30) Foreign Application Priority Data
Oct. 17, 2016 (KR) 10-2016-0134545

(51) Int. Cl. H04N 7/08; H04N 7/18

(52) U.S. Cl. CPC H04N 7/0806; G06F 3/04842; H04N 7/181

(57) ABSTRACT

Provided is an image providing method and apparatus. The image providing method includes determining a display channel group including one or more display channels; determining a display mode of the display channel group based on a user input; determining an image source of the one or more image channels belonging to the display channel group based on the determined display mode; and acquiring an image corresponding to each of the one or more image channels from the determined image source and displaying the acquired image on the display.

### CROSS-REFERENCE TO RELATED APPLICATION

This application claims priority from and benefit of Korean Patent Application No. 10-2016-0134545, filed on Oct. 17, 2016 in the Korean Intellectual Property Office, the disclosure of which is incorporated herein by reference in its entirety.

### BACKGROUND

### 1. Field

One or more exemplary embodiments relate to image providing apparatuses and methods.

### 2. Description of the Related Art

Nowadays, surveillance cameras are installed in many places, and technologies for detecting, recording, and storing events that occur in images acquired by the surveillance cameras have been developed.

In particular, as the number of installed surveillance cameras constantly increases, multi-channel image display apparatuses for receiving images from a plurality of cameras in order to survey a surveillance target region have been actively developed.

However, such an image providing apparatus provides a real-time (or live) image and a recorded image according to different layouts and interfaces, thus causing user confusion.

### SUMMARY

One or more exemplary embodiments include image providing apparatuses and methods that may provide a real-time (or live) image and a recorded image according to the same layout and interface, thus preventing user confusion.

Further, one or more exemplary embodiments include various image providing apparatuses and methods that may provide a plurality of image channels in a grouped manner.

Further still, one or more exemplary embodiments include image providing apparatuses and methods that may provide channel group-by-group images to a user, thus allowing easy image identification by the user.

According to an aspect of an exemplary embodiment, there is provided an image providing method including: determining a display channel group including one or more image channels; determining a display mode of the display channel group based on a user input; determining an image source of the one or more image channels belonging to the display channel group based on the determined display mode; and acquiring an image corresponding to each of the one or more image channels from the determined image source and displaying the acquired image on the display.

The display channel group may correspond to a first display channel group, the method may further include providing a plurality of display channel groups including the first display channel group, and each of the plurality of display channel groups may include one or more image channels.

The determining of the display channel group may determine at least one of the plurality of display channel groups as the first display channel group based on a user input.

The image providing method may further include, before the determining of the display channel group, generating one or more display channel groups based on a user input and determining one or more image channels belonging to each of the generated one or more display channel groups.

The image providing method may further include, before the determining of the display channel group, classifying one or more ungrouped image channels into one or more display channel groups based on attribute information of the one or more ungrouped image channels.

The attribute information may include information about an event detection count of the one or more ungrouped image channels and information about a detection event type of the one or more ungrouped image channels.

The attribute information may include position information of the one or more ungrouped image channels, the position information may include one or more position names representing a position of the one or more ungrouped image channels in one or more scopes, and the classifying may include classifying the one or more ungrouped image channels into one or more display channel groups based on the one or more position names of the position information.

The one or more image channels may be included in one or more display channel groups.

The display mode may include at least one of a live image display mode and a recorded image display mode.

When the display mode is the live image display mode, the determining of the image source may include determining the image source of the one or more image channels as a surveillance camera corresponding to each of the one or more image channels. When the display mode is the recorded image display mode, the determining of the image source may include determining the image source of the one or more image channels as a storage that stores the image.

The displaying may include displaying the image corresponding to each of the one or more image channels at a predetermined position of the display regardless of the display mode and the image source.

According to an aspect of another exemplary embodiment, there is provided an image providing apparatus including a processor configured to: determine a display channel group including one or more image channels; determine a display mode of the display channel group based on a user input; determine an image source of the one or more image channels belonging to the display channel group based on the determined display mode; and acquire an image corresponding to each of the one or more image channels from the determined image source and display the acquired image on the display.

The display channel group may correspond to a first display channel group, the first display channel group may be one of a plurality of display channel groups, and the processor may determine at least one of the plurality of display channel groups as the first display channel group based on a user input.

Before the processor determines the display channel group, the processor may generate one or more display channel groups based on a user input and determine one or more image channels belonging to each of the generated one or more display channel groups.

Before the processor determines the display channel group, the processor may classify one or more ungrouped image channels into one or more display channel groups based on attribute information of the one or more ungrouped image channels.

The attribute information may include information about an event detection count of the one or more ungrouped image channels and information about a detection event type of the one or more ungrouped image channels.

The attribute information may include position information of the one or more ungrouped image channels, the position information may include one or more position names representing a position of the one or more ungrouped image channels in one or more scopes, and the processor may classify the one or more ungrouped image channels into one or more display channel groups based on the one or more position names of the position information.

The display mode may include at least one of a live image display mode and a recorded image display mode.

When the display mode is the live image display mode, the processor may determine the image source of the one or more image channels as a surveillance camera corresponding to each of the one or more image channels. When the display mode is the recorded image display mode, the processor may determine the image source of the one or more image channels as a storage that stores the image.

The processor may control to display the image corresponding to each of the one or more image channels at a predetermined position of the display regardless of the display mode and the image source.

According to an aspect of another exemplary embodiment, there is provided method of displaying video data obtained from a plurality of surveillance cameras, including: determining a display mode at least between a live image display mode and a recorded image display mode; displaying a first interface that allows a user to select one of a plurality of camera groups and a second interface that allows the user select to one of the live image display mode and the recorded image display mode; displaying, in a display layout, one or more videos acquired in real time from cameras belonging to the selected camera group in response to the live image display mode being selected; and displaying, in the same display layout, the one or more videos that are acquired from the cameras belonging to the selected group and then stored in a storage, in response to the recorded image display mode being selected.

### BRIEF DESCRIPTION OF THE DRAWINGS

The above and/or other aspects will be more apparent by describing certain exemplary embodiments, with reference to the accompanying drawings, in which:

FIG. 1 schematically illustrates an image providing system according to an exemplary embodiment;

FIG. 2 schematically illustrates a configuration of an image providing apparatus according to an exemplary embodiment;

FIG. 3 illustrates an installation example of an image providing system according to an exemplary embodiment;

FIG. 4 illustrates an example of a screen displayed on a display unit according to an exemplary embodiment;

FIG. 5A illustrates an example of a display screen of a “First Floor” group of FIG. 3 according to an exemplary embodiment;

FIG. 5B illustrates an example of a display screen of a “First Floor Hallway” group of FIG. 3 according to an exemplary embodiment;

FIG. 6A illustrates an example of a screen for setting a backup of each image channel in an image providing apparatus according to an exemplary embodiment;

FIG. 6B illustrates an example of a screen for displaying detailed setting items of each image channel according to an exemplary embodiment; and

FIG. 7 is a flow diagram illustrating an image providing method performed by an image providing apparatus of FIG. 1 according to an exemplary embodiment.

### DETAILED DESCRIPTION

Exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions are not described in detail since they would obscure the description with unnecessary detail.

As used herein, the term “and/or” includes any and all combinations of one or more of the associated listed items. Expressions such as “at least one of,” when preceding a list of elements, modify the entire list of elements and do not modify the individual elements of the list.

Although terms such as “first” and “second” may be used herein to describe various elements or components, these elements or components should not be limited by these terms. These terms are only used to distinguish one element or component from another element or component.

The terms used herein are for the purpose of describing particular embodiments only and are not intended to limit the inventive concept. As used herein, the singular forms “a”, “an”, and “the” are intended to include the plural forms as well, unless the context clearly indicates otherwise. It will be understood that terms such as “comprise”, “include”, and “have”, when used herein, specify the presence of stated features, integers, steps, operations, elements, components, or combinations thereof, but do not preclude the presence or addition of one or more other features, integers, steps, operations, elements, components, or combinations thereof.

The exemplary embodiments may be described in terms of functional block components and various processing operations. Such functional blocks may be implemented by any number of hardware and/or software components that execute particular functions. For example, the exemplary embodiments may employ various integrated circuit (IC) components, such as memory elements, processing elements, logic elements, and lookup tables, which may execute various functions under the control of one or more microprocessors or other control devices. Similarly, where the elements of the exemplary embodiments may be implemented by software programming or software elements, the exemplary embodiments may be implemented by any programming or scripting language such as C, C++, Java, or assembly language, with various algorithms being implemented by any combination of data structures, processes, routines, or other programming elements. Functional aspects may be implemented by an algorithm that is executed in one or more processors. Terms such as “mechanism”, “element”, “unit”, and “configuration” may be used in a broad sense, and are not limited to mechanical and physical configurations. The terms may include the meaning of software routines in conjunction with processors or the like.

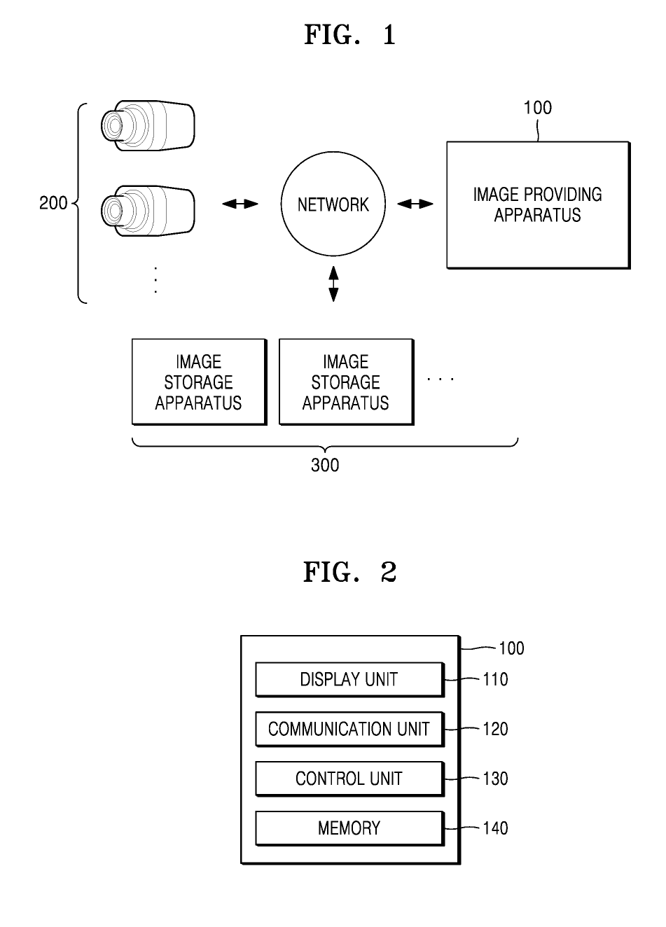

FIG. 1 schematically illustrates an image providing system according to an exemplary embodiment.

Referring to FIG. 1, an image providing system according to an exemplary embodiment may include an image providing apparatus 100, a surveillance camera 200, and an image storage apparatus 300.

According to an exemplary embodiment, the surveillance camera 200 may be an apparatus including a lens and an image sensor. The lens may be a lens group including one or more lenses. The image sensor may convert an image, which is input by the lens, into an electrical signal. For example, the image sensor may be a semiconductor device such as a charge-coupled device (CCD) or a complementary metal oxide semiconductor (CMOS) that may convert an optical signal into an electrical signal (hereinafter described as an image).

The surveillance camera 200 may be, for example, a camera that provides an RGB image of a target space, an infrared image, or a distance image including distance information.

Also, the surveillance camera 200 may further include an event detecting unit. The event detecting unit may be, for example, a human and/or animal motion detecting unit such as a passive infrared sensor (PIR) sensor or an infrared sensor. The event detecting unit may be an environment change detecting unit such as a temperature sensor, a humidity sensor, or a gas sensor. Also, the event detecting unit may be a unit for determining the occurrence/nonoccurrence of an event by comparing images acquired over time. However, this is merely an example, and it may vary according to the installation place and/or purpose of the image providing system.

The surveillance camera 200 may be arranged in various ways such that no dead angle exists in a surveillance target region. For example, the surveillance camera 200 may be arranged such that the sum of the view angles of the surveillance camera 200 is equal to or greater than that of the surveillance target region. In this case, the surveillance target region may be various spaces that need to be monitored by a manager. For example, the surveillance target region may be any space such as an office, a public facility, a school, or a house where there is a concern about theft of goods. Also, the surveillance target region may be any space such as a factory, a power plant, or an equipment room where there is a concern about accident occurrence. However, this is merely an example, and the inventive concept is not limited thereto.

The surveillance camera 200 may transmit information about event occurrence/nonoccurrence and/or acquired images to the image providing apparatus 100 and/or the image storage apparatus 300 through a network. The network described herein may be, for example, but is not limited to, wireless network, wired network, public network such as Internet, private network, Global System for Mobile communications (GSM) network, General Packet Radio Service (GPRS) network, Local Area Network (LAN), Wide Area Network (WAN), Metropolitan Area Network (MAN), cellular network, Public Switched Telephone Network (PSTN), Personal Area Network (PAN), Bluetooth, Wi-Fi Direct (WFD), Near Field Communication (NFC), Ultra Wide Band (UWB), any combination thereof, or any other network.

Herein, the surveillance camera 200 may include one or more surveillance cameras. Hereinafter, for convenience of description, it is assumed that the surveillance camera 200 includes a plurality of surveillance cameras.

According to an exemplary embodiment, the image storage apparatus 300 may receive multimedia objects such as voices and images, which are acquired by the surveillance camera 200, from the surveillance camera 200 through the network and store the received multimedia objects. Also, at the request of the image providing apparatus 100, the image storage apparatus 300 may provide the multimedia objects such as voices and images stored in the image storage apparatus 300.

The image storage apparatus 300 may be any unit for storing and retrieving the information processed in electronic communication equipment. For example, the image storage apparatus 300 may be an apparatus including a recording medium such as a hard disk drive (HDD), a solid state drive (SSD), or a solid state hybrid drive (SSHD) that may store information. Also, the image storage apparatus 300 may be an apparatus including a storage unit such as a magnetic tape or a video tape.

The image storage apparatus 300 may have a unique identifier (i.e., a storage apparatus identifier) for identifying the image storage apparatus 300 on the network. In this case, the storage apparatus identifier may be, for example, any one of a media access control (MAC) address and an internet protocol (IP) address of the image storage apparatus 300. Also, herein, the image storage apparatus 300 may include one or more image storage apparatuses.

FIG. 2 schematically illustrates a configuration of the image providing apparatus 100 according to an exemplary embodiment.

Referring to FIG. 2, the image providing apparatus 100 may include a display unit 110, a communication unit 120, a control unit 130, and a memory 140.

According to an exemplary embodiment, the display unit 110 may include a display that displays figures, characters, or images according to the electrical signal generated by the control unit 130. For example, the display unit 110 may include any one of a cathode ray tube (CRT), a liquid crystal display (LCD), a plasma display panel (PDP), a light-emitting diode (LED), and an organic light-emitting diode (OLED); however, the inventive concept is not limited thereto.

According to an exemplary embodiment, the communication unit 120 may include a device storing software and including hardware necessary for the image providing apparatus 100 to communicate control signals and/or images with an external apparatus such as the surveillance camera 200 and/or the image storage apparatus 300 through a wired/wireless connection. The communication unit 120 may be also referred to as a communication interface.

According to an exemplary embodiment, the control unit 130 may include any device such as a processor that may process data. Herein, the processor may include, for example, a data processing device that is embedded in hardware and has a physically structured circuit to perform a function represented by the commands or codes included in a program. As an example, the data processing device embedded in hardware may include any processing device such as a microprocessor, a central processing unit (CPU), a processor core, a multiprocessor, an application-specific integrated circuit (ASIC), or a field programmable gate array (FPGA); however, the inventive concept is not limited thereto.

According to an exemplary embodiment, the memory 140 may temporarily or permanently store the data processed by the image providing apparatus 100. The memory 140 may include magnetic storage media or flash storage media; however, the exemplary embodiment is not limited thereto.

Also, according to an exemplary embodiment, the image providing apparatus 100 may be, for example, an apparatus included in any one of a video management system (VMS), a content management system (CMS), a network video recorder (NVR), and a digital video recorder (DVR). Also, according to an exemplary embodiment, the image providing apparatus 100 may be an independent apparatus separately provided from the VMS, the CMS, the NVR, and the DVR. However, this is merely an example, and the exemplary embodiment is not limited thereto.

Hereinafter, a description will be given of various exemplary embodiments in which the control unit 130 determines an image displayed on the display unit 110.

According to an exemplary embodiment, the control unit 130 may generate one or more display channel groups based on various methods and determine one or more image channels belonging to the generated display channel group.

For example, the control unit 130 may generate one or more display channel groups based on a user input and determine one or more image channels belonging to each of the generated one or more display channel groups. In other words, the user may generate a group according to his/her need and include one or more image channels in the generated group.

As an example, the control unit 130 may generate a display channel group of a “Lecture Room” group and include a plurality of channels for displaying the images acquired by the surveillance cameras installed in a plurality of lecture rooms, in the “Lecture Room” group.

As another example, the control unit 130 may generate a display channel group of a “Main Path” group and include a plurality of channels for displaying the images acquired by the surveillance cameras installed in a path along which pedestrians move most frequently, in the “Main Path” group.

Also, according to an exemplary embodiment, the control unit 130 may classify one or more ungrouped image channels into one or more display channel groups based on attribute information of the image channels.

Herein, the attribute information may include, for example, information about an event detection count of the image channels. In this case, the control unit 130 may classify one or more image channels into one or more display channel groups based on the event detection count of each image channel.

As an example, the control unit 130 may classify a channel having an event detection count equal to or greater than a predetermined threshold count as a display channel group of an “Event” group. Also, the control unit 130 may classify a channel having an event detection count equal to or greater than a predetermined threshold count within a predetermined time interval as a display channel group of a “Marked” group.

According to the exemplary embodiment, information about the main channel over time may be provided efficiently.

Also, the attribute information of the image channels may include information about a detection event type of the image channels. In this case, the control unit 130 may classify one or more image channels into one or more display channel groups according to the type of an event detected in each image channel.

As an example, the control unit 130 may classify a channel detecting a motion detection event as a display channel group of a “Motion Detection” group and may classify a channel detecting a sound event as a display channel group of a “Sound Detection” group.

According to the exemplary embodiment, the control unit 130 may collect and provide information about the high-probability channels.

Also, the attribute information of the image channels may include position information of the image channels (e.g., information about locations of surveillance cameras that transmit image data through the image channels). Herein, the position information may include one or more position names representing the position of one or more image channels in one or more scopes (e.g., a position in an area surround by a closed loop).

As an example, the position information of an image channel may include one or more position names such as “Main Building” representing the position in the widest scope, “First Floor” representing the position in the next scope, and “Restaurant” representing the position in the narrowest scope. All of the above three position names may represent the position of the corresponding image channel while being different just in scope. Herein, the expression “position information of a channel” may refer to information about the position of the surveillance camera 200 acquiring an image of the channel.

The control unit 130 may classify one or more image channels into one or more display channel groups based on the above position names of the image channels. As an example, the control unit 130 may classify all image channels having a position name “Main Building” in the position information as a display channel group of a “Main Building” group. Also, the control unit 130 may classify all image channels having a position name “Lecture Room” as a display channel group of a “Lecture Room” group.

According to the exemplary embodiment, the control unit 130 may allow the user to monitor the surveillance target regions in different surveillance ranges.

According to an exemplary embodiment, the control unit 130 may determine a display channel group displayed on the display unit 110. In other words, the control unit 130 may determine a display channel group to be displayed on the display unit 110, among the above one or more display channel groups generated in various ways.

For example, the control unit 130 may determine at least one of one or more display channel groups as the display channel group displayed on the display unit 110 based on a user input.

As an example, when a display channel group such as a “Main Building” group, a “Lecture Room” group, a “Hallway” group, and a “Staircase” group is generated, the control unit 130 may determine the display channel group displayed based on a user input for selecting any one of the above four channel groups. In other words, the control unit 130 may perform control such that the display channel group selected by the user may be displayed on the display unit 110.

Also, the control unit 130 may determine at least one of one or more display channel groups as the display channel group displayed on the display unit 110 based on a preset method.

As an example, when four channel groups are generated as in the above example, the control unit 130 may determine the above four channel groups as the display channel groups displayed sequentially on the display unit 110. In other words, the control unit 130 may perform control such that the four channel groups may be sequentially displayed on the display unit 110.

According to an exemplary embodiment, the control unit 130 may determine a display mode of the determined display channel group based on a user input. Also, the control unit 130 may determine an image source of one or more image channels belonging to the display channel group based on the determined display mode.

Herein, the display mode may include a live image display mode and a recorded image display mode. Also, the image source may include the surveillance camera 200 providing a live image and the image storage apparatus 300 providing a recorded image.

When the user performs an input corresponding to the live image display mode, the control unit 130 may determine the display mode of the display channel group as the live image display mode and determine the image source as the surveillance camera 200 corresponding to each of the one or more image channels. Herein, the one or more image channels may be the channels belonging to the display channel group determined by the above process.

Also, when the user performs an input corresponding to the recorded image display mode, the control unit 130 may determine the display mode of the display channel group as the recorded image display mode and determine the image source as one or more image storage apparatuses 300.

According to an exemplary embodiment, the control unit 130 may acquire an image corresponding to each of the one or more image channels belonging to the display channel group from the determined image source and display the acquired image on the display unit 110.

For example, when the display mode is the live image display mode, the control unit 130 may acquire an image from the surveillance camera 200 corresponding to each of the one or more image channels belonging to the display channel group and display the acquired image on the display unit 110.

Also, when the display mode is the recorded image display mode, the control unit 130 may acquire an image from the image storage apparatus 300 corresponding to each of the one or more image channels belonging to the display channel group and display the acquired image on the display unit 110.

According to the exemplary embodiment, the user may view a real-time (or live) image and a recorded image in the same layout. In other words, the control unit 130 may display the image of the one or more image channels belonging to the display channel group at a predetermined position of the display unit 110 regardless of the display mode and/or the image source of the one or more image channels.

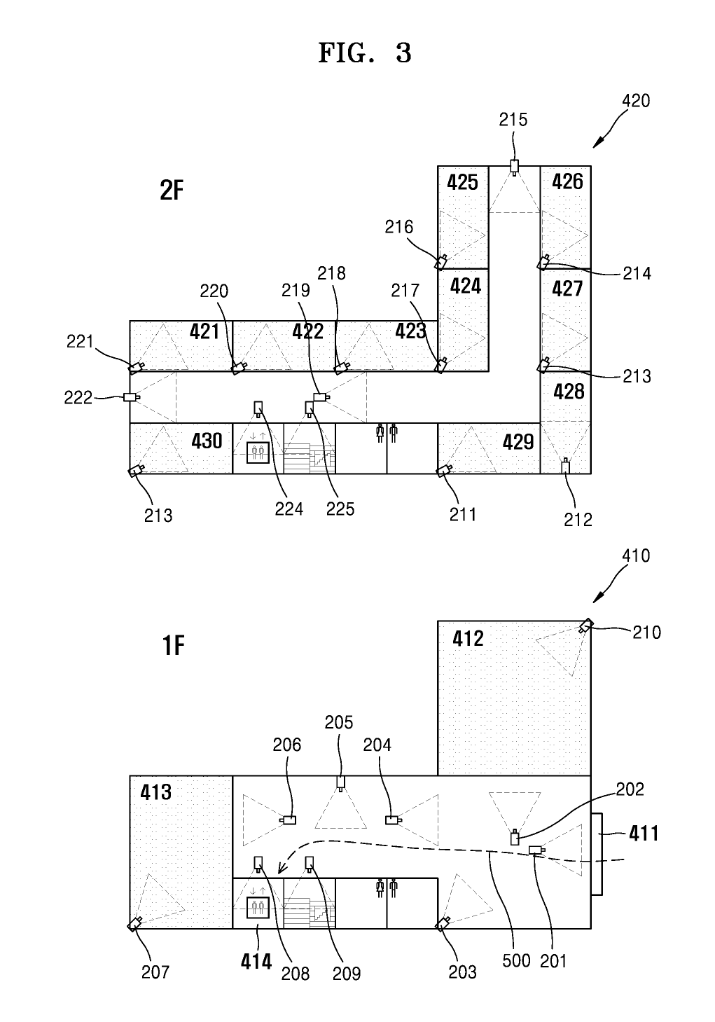

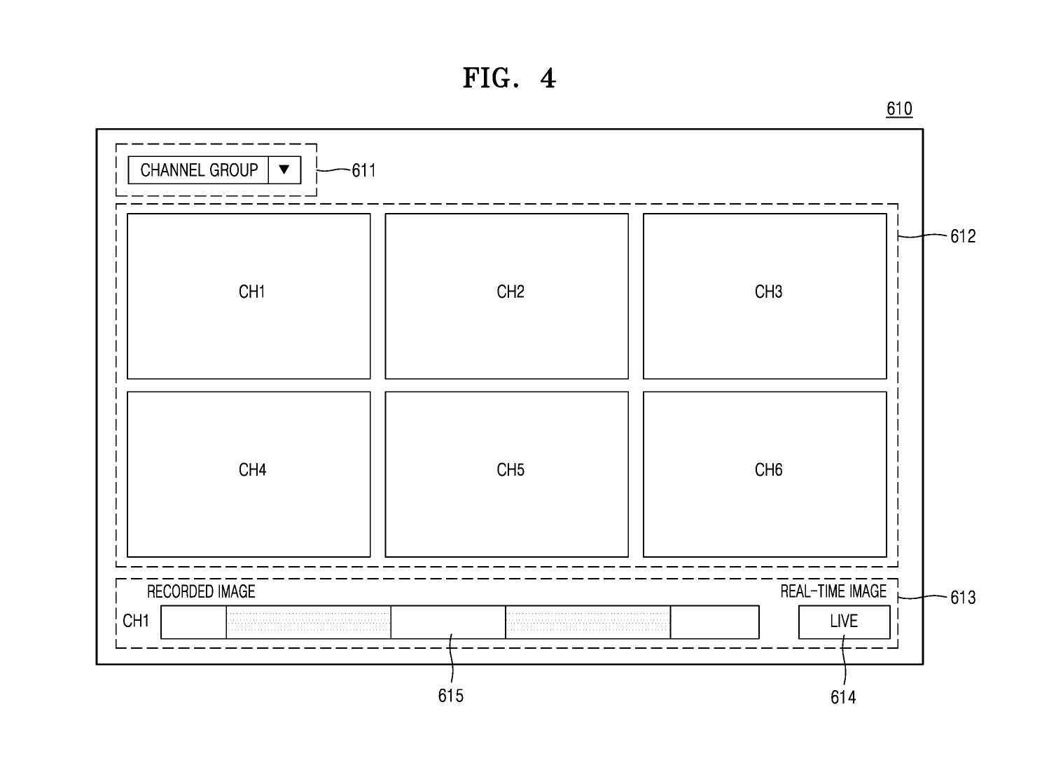

FIG. 3 illustrates an installation example of the image providing system according to an exemplary embodiment.

Referring to FIG. 3, it is assumed that the image providing system is installed in a school building including two floors 410 and 420. Herein, it is assumed that the first floor 410 includes a doorway 411, a lecture hall 412, and a restaurant 413 and ten surveillance cameras 201 to 210 are installed on the first floor 410.

Also, it is assumed that ten lecture rooms 421 to 430 exist on the second floor 420 and fifteen surveillance cameras 211 to 225 are installed on the second floor 420.

Under this assumption, the control unit 130 may generate display channel groups as shown in Table 1 below.

TABLE 1

| | | Surveillance Cameras |
|---|---|---|
| Classification | Group Name | (Image Channels) |
| User Input | Lecture Room | 211, 212, 213, 214, 216, |
| | | 217, 218, 220, 221, 223 |
| | Main Path (500) | 201, 203, 204, 205, 208 |
| Attribute | Motion | 201, 202, 203 |
| Information | Detection | |
| | Marked | 222, 223, 221 |
| | First Floor | 201 to 210 |
| | Staircase | 209, 225 |
| | First Floor | 201, 202, 203, 204, 205, 206 |
| | Hallway | |

Herein, in the case of the “Motion Detection” group and the “Marked” group, since the group may be determined based on the event detection information of each surveillance camera (image channel) in a certain time zone, the surveillance camera (image channel) included in the corresponding group may change over time.

Also, the display channel groups shown in Table 1 are merely examples, and more display channel groups may be generated in addition to the display channel groups shown in Table 1.

FIG. 4 illustrates an example of a screen 610 displayed on the display unit 110 according to an exemplary embodiment.

Referring to FIG. 4, the screen 610 may include a first interface 611 for selecting a display channel group to be displayed on the screen 610, an image display region 612 for displaying an image of one or more image channels belonging to the selected display channel group, and a second interface 613 for selecting an image source of an image channel. The display channel group of the first interface 611 may be also indicated to as a camera group including a plurality of cameras that use channels CH1-CH6 to transmit video data to the image providing apparatus 100. A plurality of regions labeled as CH1-CH6 in the image display region 612 may respectively display videos obtained from the plurality of cameras.

The first interface 611 for selecting the display channel group may provide the user with the display channel group generated by the above method and acquire selection information from the user. Although a drop-down menu is illustrated as the first interface 611 in FIG. 4, the exemplary embodiment is not limited thereto and any interface for selecting any one of a plurality of items may be used as the first interface 611.

Also, the number of images included in the image display region 612 may vary according to the number of channels included in the display channel group selected by the user. For example, when the user selects the “First Floor” group in Table 1, the image display region 612 may include ten images.

As an alternative exemplary embodiment, the image display region 612 may display the images of the channels included in the display channel group at a certain size and display the images on a plurality of pages in a divided manner when the number of channels included in the display channel group increases. For example, when the image display region 612 may display the images of up to six channels at a time and the number of channels included in the display channel group is 10, the image display region 612 may sequentially display a first page displaying the images of six channels and a second page displaying the images of the other four channels. However, this is merely an example, and the exemplary embodiment is not limited thereto.

The second interface 613 for selecting the image source of the image channel may include a button 614 for selecting the image source as a surveillance camera and a time slider 615 for selecting the image source as any one time point of the recorded image. The second interface 613 may be used to simultaneously operate all the channels displayed in the image display region 612 or may be used to operate only a particular channel selected by the user. Although FIG. 4 illustrates that a first channel CH1 is operated, the exemplary embodiment is not limited thereto.

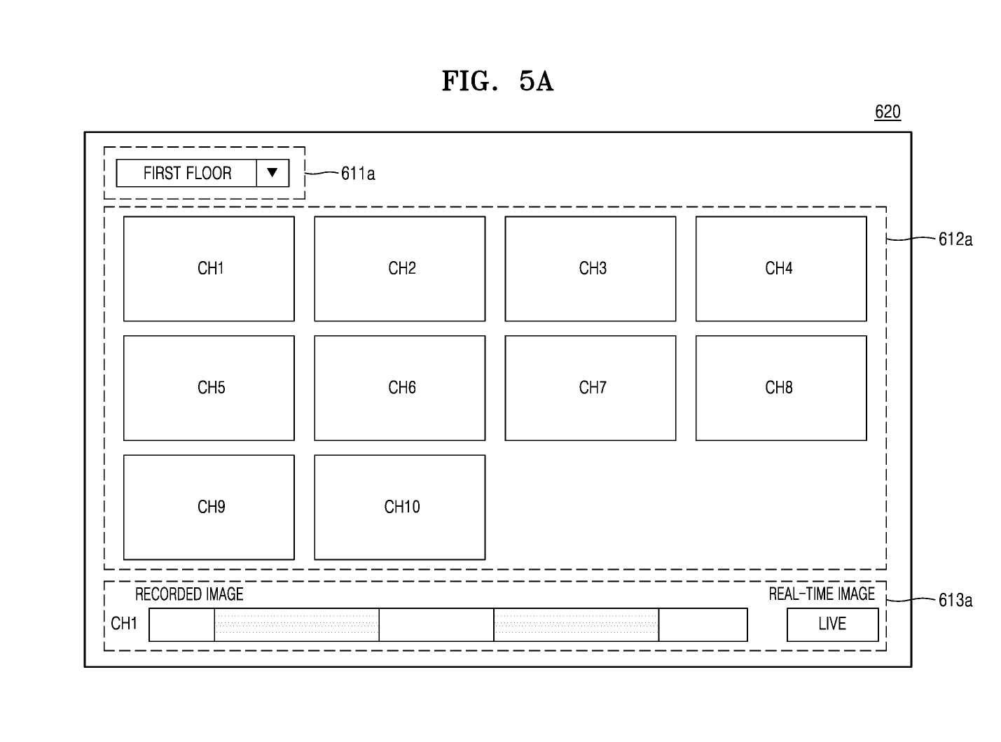

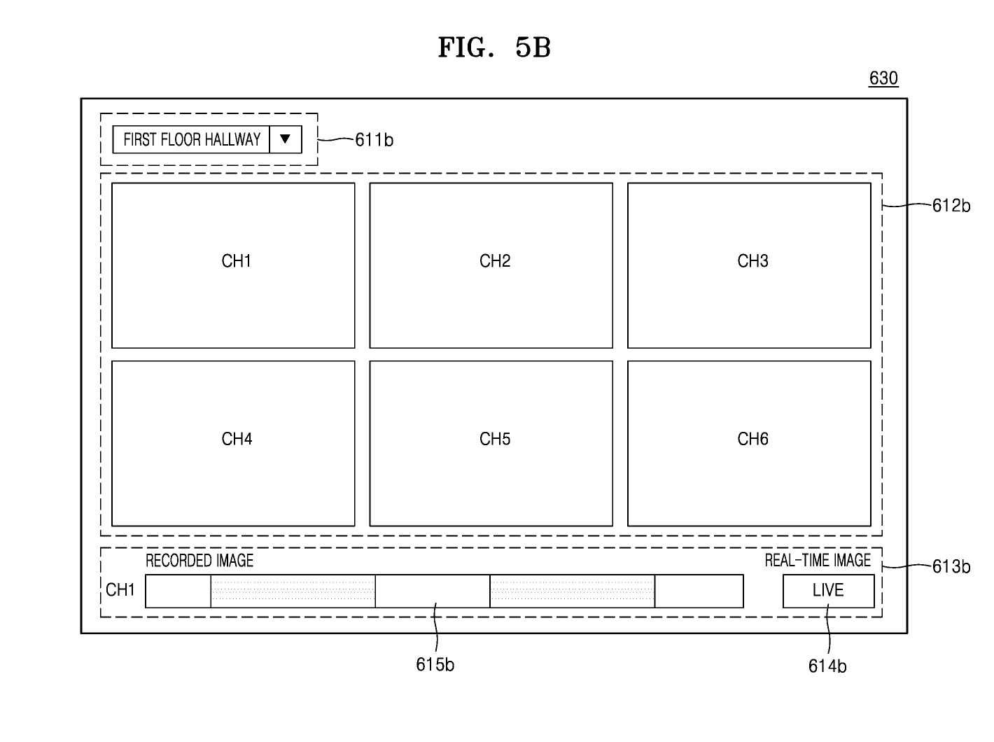

FIG. 5A illustrates an example of a display screen 620 of the “First Floor” group of FIG. 3.

Referring to FIG. 5A, the screen 620 may include a first interface 611a for selecting the “First Floor” group, an image display region 612a for displaying the images of ten image channels belonging to the “First Floor” group selected, and a second interface 613a for selecting an image source of an image channel.

Herein, the image display region 612a may display the real-time images acquired by the surveillance cameras 201 to 210 and may display the images acquired by the surveillance cameras 201 to 210 and then stored in the image storage apparatus 300.

FIG. 5B illustrates an example of a display screen 630 of the “First Floor Hallway” group of FIG. 3.

Referring to FIG. 5B, the screen 630 may include a first interface 611b for selecting the “First Floor Hallway” group, an image display region 612b for displaying the images of six image channels belonging to the “First Floor Hallway” group selected, and a second interface 613b for selecting an image source of an image channel.

Herein, unlike in FIG. 5A, the image display region 612b may display six real-time images acquired by the surveillance cameras 201, 202, 203, 204, 205, and 206 and may display the images acquired by the surveillance cameras 201, 202, 203, 204, 205, and 206 and then stored in the image storage apparatus 300.

Herein, for example, when the user selects a first channel CH1 and selects a “LIVE” button 614b in the interface 613b for selecting the image source, the real-time image acquired by the surveillance camera 201 may be displayed in a region of the image display region 612b in which the first channel CH1 is displayed. Also, when the user selects a time point of a time slider 615b in the interface 613b for selecting the image source, a recorded image about the selected time point may be displayed in a region of the image display region 612b in which the first channel CH1 is displayed. Herein, the recorded image may be received from the image storage apparatus 300. In addition, the user may select all the channels CH1 to CH6 and click the “LIVE” button 614b so that the real-time images acquired by the surveillance cameras 201-206 are simultaneously displayed in corresponding regions of the image display region 612b. Also, the user may select all the channels CH1 to CH6 and recorded images so that the recorded images from the channels CH1 to CH6 are reproduced in the corresponding regions of the image display region 612b at the same time.

In this manner, the user may easily view the recorded image and the real-time image in a switched manner with respect to the same channel group and the same channel.

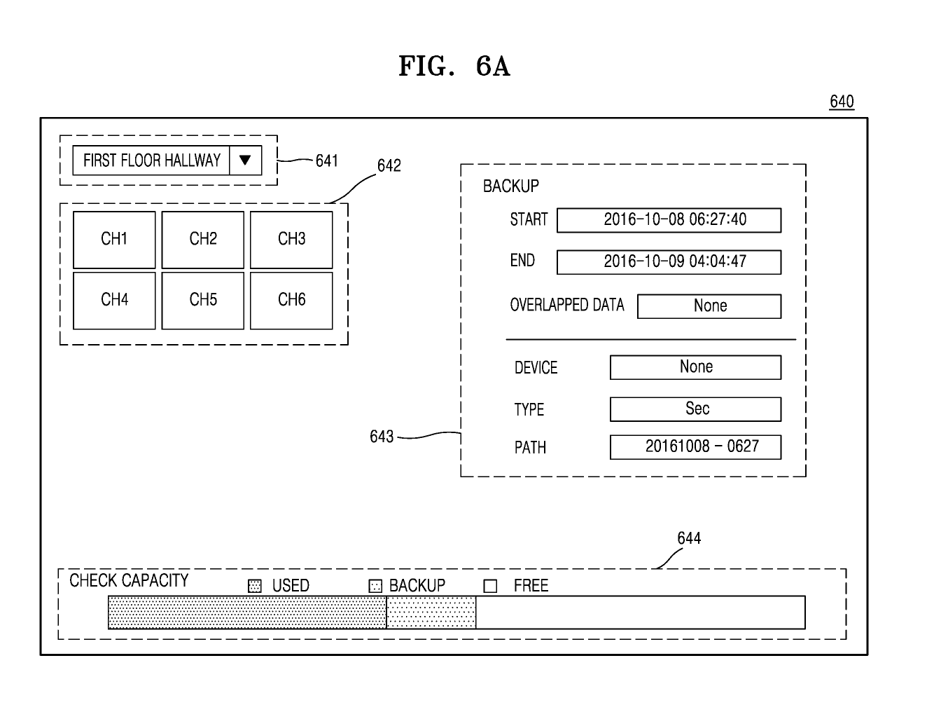

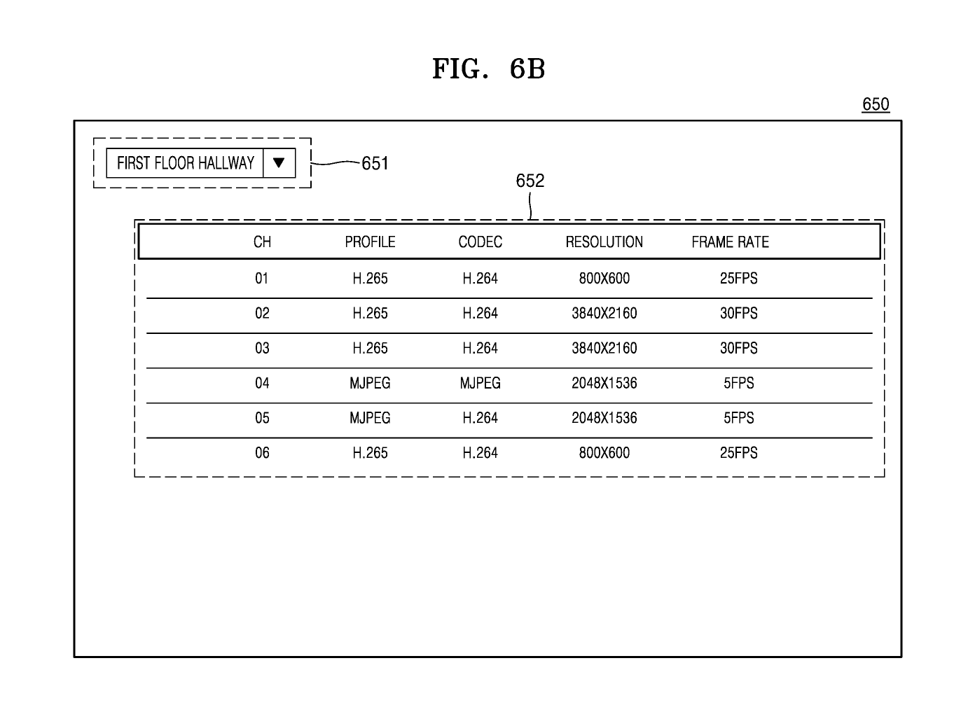

FIG. 6A illustrates an example of a screen 640 for setting a backup of an image channel in the image providing apparatus 100 according to an exemplary embodiment.

In general, the image channels belonging to the same display channel group are likely to require the same backup setting. For example, in the case of the “First Floor Hallway” group as in the example of FIG. 5B, since persons may move along the hallway 24 hours a day, there may be a need for a backup for the images in all the time zones. Also, in the case of “Lecture Room” group, since persons may move in and out the lecture room only in a certain time zone, there may be a need for a backup for only the time zone in which persons move in and out the lecture room.

In this manner, the image channels belonging to the same display channel group may require similar backup settings. However, in the related art, the user may be inconvenienced by having to separately perform the backup setting of each image channel.

However, according to an exemplary embodiment, the image providing apparatus 100 may provide an environment for setting a backup for each display channel group, thus reducing the above inconvenience.

In more detail, according to an exemplary embodiment, the screen 640 for setting a backup of the image channel displayed by the image providing apparatus 100 may include an interface 641 for selecting a display channel group to be set, a region 642 for displaying one or more image channels belonging to the selected display channel group, a setting interface 643 for performing detailed backup settings, and an indicator 644 for displaying the current use state of the image storage apparatus 300.

The interface 641 for selecting the display channel group may provide the user with the display channel group generated by the above method and acquire selection information from the user. Although a drop-down menu is illustrated as the interface 641 in FIGS. 6A and 6B, the exemplary embodiment is not limited thereto and any interface for selecting any one of a plurality of items may be used as the interface 641.

Also, the region 642 for displaying the one or more image channels may display the image channel belonging to the display channel group selected by the user through the interface 641. Herein, the expression “displaying the image channel” may refer to displaying a mark corresponding to the channel (e.g., a figure including the name and the identification number of the channel). Also, the expression “displaying the image channel” may refer to displaying a captured image and/or a real-time image of the channel. However, this is merely an example, and the exemplary embodiment is not limited thereto.

The setting interface 643 may include an interface for setting one or more backup setting items. For example, as illustrated in FIG. 6A, the setting interface 643 may include an interface for setting a time interval to be backed up, an interface for performing settings on redundant data processing, and an interface for selecting an image storage apparatus to store a backup image.

In this case, the user may select a particular channel in the region 642 for displaying the one or more image channels and perform backup settings only on the selected particular channel, or may perform backup settings on the entire display channel group selected.

FIG. 6B illustrates an example of a screen 650 for displaying detailed setting items of each image channel according to an exemplary embodiment.

Like in the example of FIG. 6A, the screen 650 may include an interface 651 for selecting a display channel group to be set. Also, the screen 650 may include a region 652 for displaying the setting item-by-item setting values of one or more image channels belonging to the selected display channel group.

The region 652 for displaying the setting item-by-item setting values of the one or more image channels may display each channel together with detailed setting values. For example, as illustrated in FIG. 6B, the frame rate, the resolution, the codec, and the profile of each channel may be displayed in the region 652. In this case, the user may select and change any one of the setting values displayed in the region 652.

Accordingly, the exemplary embodiment may allow the user to view the real-time image and the recorded image in the same layout and to perform the backup setting and the channel setting in the same layout.

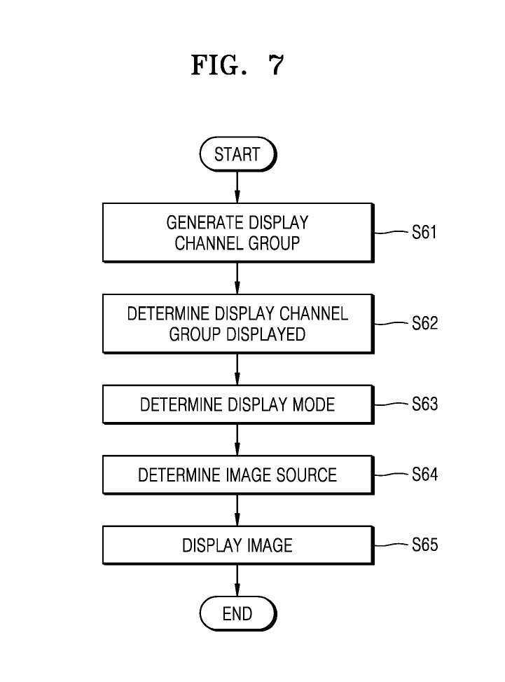

FIG. 7 is a flow diagram illustrating an image providing method performed by the image providing apparatus 100 of FIG. 1. Hereinafter, redundant descriptions overlapping with those described in FIGS. 1 to 6B will be omitted for conciseness.

According to an exemplary embodiment, the image providing apparatus 100 may generate one or more display channel groups based on various methods and determine one or more image channels belonging to the generated display channel group (operation S61).

For example, the image providing apparatus 100 may generate one or more display channel groups based on a user input and determine one or more image channels belonging to each of the generated one or more display channel groups. In other words, the user may generate a group according to his need and include one or more image channels in the generated group.

Also, the image providing apparatus 100 may classify one or more ungrouped image channels into one or more display channel groups based on attribute information of the image channels.

Herein, the attribute information may include, for example, information about an event detection count of the image channels. In this case, the image providing apparatus 100 may classify one or more image channels into one or more display channel groups based on the event detection count of each image channel. According to the exemplary embodiment, information about the main channel over time may be provided efficiently.

Also, the attribute information of the image channels may include information about a detection event type of the image channels. In this case, the image providing apparatus 100 may classify one or more image channels into one or more display channel groups according to the type of an event detected in each image channel. According to the exemplary embodiment, information about the high-probability channels may be collected and provided.

Also, the attribute information of the image channels may include position information of the image channels. Herein, the position information may include one or more position names representing the position of one or more image channels in one or more scopes. The image providing apparatus 100 may classify one or more image channels into one or more display channel groups based on the above position names of the image channels. According to the exemplary embodiment, the image providing apparatus 100 may allow the user to monitor the surveillance target regions in different surveillance ranges.

According to an exemplary embodiment, the image providing apparatus 100 may determine a display channel group displayed on the display unit 110 (operation S62). In other words, the image providing apparatus 100 may determine a display channel group to be displayed on the display unit 110, among the above one or more display channel groups generated in various ways.

For example, the image providing apparatus 100 may determine at least one of one or more display channel groups as the display channel group displayed on the display unit 110 based on a user input.

Also, the image providing apparatus 100 may determine at least one of one or more display channel groups as the display channel group displayed on the display unit 110 based on a preset method.

According to an embodiment, the image providing apparatus 100 may determine a display mode of the determined display channel group based on a user input (operation S63). Also, the image providing apparatus 100 may determine an image source of one or more image channels belonging to the display channel group based on the determined display mode (operation S64).

Herein, the display mode may include a live image display mode and a recorded image display mode. Also, the image source may include the surveillance camera 200 providing a live image and the image storage apparatus 300 providing a recorded image.

When the image providing apparatus 100 receives an input corresponding to the live image display mode, the image providing apparatus 100 may determine the display mode of the display channel group as the live image display mode and determine the image source as the surveillance camera 200 corresponding to each of the one or more image channels. Herein, the one or more image channels may be the channels belonging to the display channel group determined by the above process.

Also, when the image providing apparatus 100 receives an input corresponding to the recorded image display mode, the image providing apparatus 100 may determine the display mode of the display channel group as the recorded image display mode and determine the image source as one or more image storage apparatuses 300.

According to an exemplary embodiment, the image providing apparatus 100 may acquire an image corresponding to each of the one or more image channels belonging to the display channel group from the determined image source and display the acquired image on the display unit 110 (operation S65).

For example, when the display mode is the live image display mode, the image providing apparatus 100 may acquire an image from the surveillance camera 200 corresponding to each of the one or more image channels belonging to the display channel group and display the acquired image on the display unit 110.

Also, when the display mode is the recorded image display mode, the image providing apparatus 100 may acquire an image from the image storage apparatus 300 corresponding to each of the one or more image channels belonging to the display channel group and display the acquired image on the display unit 110.

According to the exemplary embodiment, the image providing apparatus 100 may allow the user to view the real-time image and the recorded image in the same layout. In other words, the image providing apparatus 100 may display the image of the one or more image channels belonging to the display channel group at a predetermined position of the display unit 110 regardless of the display mode and/or the image source of the one or more image channels.

The image providing methods according to the exemplary embodiments may also be embodied as computer-readable codes on a computer-readable recording medium. The computer-readable recording medium may include any data storage device that may store data which may be thereafter read by a computer system. Examples of the computer-readable recording medium may include read-only memories (ROMs), random-access memories (RAMs), compact disk read-only memories (CD-ROMs), magnetic tapes, floppy disks, and optical data storage devices. The computer-readable recording medium may also be distributed over network-coupled computer systems so that the computer-readable codes may be stored and executed in a distributed fashion. Also, the operations or steps of the methods or algorithms according to the above exemplary embodiments may be written as a computer program transmitted over a computer-readable transmission medium, such as a carrier wave, and received and implemented in general-use or special-purpose digital computers that execute the programs. Moreover, it is understood that in exemplary embodiments, one or more units (e.g., those represented by blocks as illustrated in FIG. 2) of the above-described apparatuses and devices can include or be implemented by circuitry, a processor, a microprocessor, etc., and may execute a computer program stored in a computer-readable medium.

According to the above-described exemplary embodiments, the image providing apparatuses and methods may provide a real-time image and a recorded image according to the same layout and interface, thus preventing user confusion.

Also, the image providing apparatuses and methods may provide a plurality of image channels in a grouped manner.

In addition, the image providing apparatuses and methods may provide channel group-by-group images to the user, thus allowing easy image identification by the user.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An image providing method comprising:
determining a display channel group including one or more image channels;
determining a display mode of the display channel group based on a user input;
determining an image source of the one or more image channels belonging to the display channel group based on the determined display mode; and
acquiring an image corresponding to each of the one or more image channels from the determined image source and displaying the acquired image on the display.

2. The image providing method of claim 1, wherein:
the display channel group corresponds to a first display channel group;
the method further comprises providing a plurality of display channel groups including the first display channel group; and
each of the plurality of display channel groups includes one or more image channels.

3. The image providing method of claim 2, wherein the determining of the display channel group determines at least one of the plurality of display channel groups as the first display channel group based on a user input.

4. The image providing method of claim 1, further comprising, before the determining of the display channel group, generating one or more display channel groups based on a user input and determining one or more image channels belonging to each of the generated one or more display channel groups.

5. The image providing method of claim 1, further comprising, before the determining of the display channel group, classifying one or more ungrouped image channels into one or more display channel groups based on attribute information of the one or more ungrouped image channels.

6. The image providing method of claim 5, wherein the attribute information includes information about an event detection count of the one or more ungrouped image channels and information about a detection event type of the one or more ungrouped image channels.

7. The image providing method of claim 5, wherein
the attribute information includes position information of the one or more ungrouped image channels,
the position information includes one or more position names representing a position of the one or more ungrouped image channels in one or more scopes, and
the classifying comprises classifying the one or more ungrouped image channels into one or more display channel groups based on the one or more position names of the position information.

8. The image providing method of claim 1, wherein the display mode includes at least one of a live image display mode and a recorded image display mode.

9. The image providing method of claim 8, wherein
when the display mode is the live image display mode, the determining of the image source comprises determining the image source of the one or more image channels as a surveillance camera corresponding to each of the one or more image channels, and
when the display mode is the recorded image display mode, the determining of the image source comprises determining the image source of the one or more image channels as a storage that stores the image.

10. The image providing method of claim 9, wherein the displaying comprises displaying the image corresponding to each of the one or more image channels at a predetermined position of the display regardless of the display mode and the image source.

11. An image providing apparatus comprising a processor configured to:
determine a display channel group including one or more image channels;
determine a display mode of the display channel group based on a user input;
determine an image source of the one or more image channels belonging to the display channel group based on the determined display mode; and
acquire an image corresponding to each of the one or more image channels from the determined image source and display the acquired image on the display.

12. The image providing apparatus of claim 11, wherein the display channel group corresponds to a first display channel group, the first display channel group is one of a plurality of display channel groups, and the processor determines at least one of the plurality of display channel groups as the first display channel group based on a user input.

13. The image providing apparatus of claim 11, wherein before the processor determines the display channel group, the processor generates one or more display channel groups based on a user input and determines one or more image channels belonging to each of the generated one or more display channel groups.

14. The image providing apparatus of claim 13, wherein before the processor determines the display channel group, the processor classifies one or more ungrouped image channels into one or more display channel groups based on attribute information of the one or more ungrouped image channels.

15. The image providing apparatus of claim 14, wherein the attribute information includes information about an event detection count of the one or more ungrouped image channels and information about a detection event type of the one or more ungrouped image channels.

16. The image providing apparatus of claim 14, wherein
the attribute information includes position information of the one or more ungrouped image channels,
the position information includes one or more position names representing a position of the one or more ungrouped image channels in one or more scopes, and the processor classifies the one or more ungrouped image channels into one or more display channel groups based on the one or more position names of the position information.

17. The image providing apparatus of claim 11, wherein the display mode includes at least one of a live image display mode and a recorded image display mode.

18. The image providing apparatus of claim 17, wherein
when the display mode is the live image display mode, the processor determines the image source of the one or more image channels as a surveillance camera corresponding to each of the one or more image channels, and
when the display mode is the recorded image display mode, the processor determines the image source of the one or more image channels as a storage that stores the image.

19. The image providing apparatus of claim 11, wherein the processor controls to display the image corresponding to each of the one or more image channels at a predetermined position of the display regardless of the display mode and the image source.

20. A method of displaying video data obtained from a plurality of surveillance cameras, the method comprising:
determining a display mode at least between a live image display mode and a recorded image display mode;
displaying a first interface that allows a user to select one of a plurality of camera groups and a second interface that allows the user select to one of the live image display mode and the recorded image display mode;
displaying, in a display layout, one or more videos acquired in real time from cameras belonging to the selected camera group in response to the live image display mode being selected; and
displaying, in the same display layout, the one or more videos that are acquired from the cameras belonging to the selected group and then stored in a storage, in response to the recorded image display mode being selected.
